(19) United States
(12) Patent Application Publication
(10) Pub. No.: US 2022/0136828 A1
(43) Pub. Date: May 5, 2022

(54) SMART PEGS FOR THE CONSTRUCTION INDUSTRY

(71) Applicant: CIVDRONE LTD, Tel Aviv (IL)

(72) Inventors: Tom Jonathan YESHURUN, Tel Aviv (IL); Liav Jonathan MULLER, Tel Aviv (IL)

(73) Assignee: CIVDRONE LTD, Tel Aviv (IL)

(21) Appl. No.: 17/429,948

(22) PCT Filed: Feb. 13, 2020
(86) PCT No.: PCT/IL2020/050167

§ 371 Date: Aug. 11, 2021

(30) Foreign Application Priority Data
Feb. 13, 2020 (IL) 264822

(51) Int. Cl. G01C 15/00; G01C 15/06

(52) U.S. Cl. CPC G01C 15/002; G01C 15/06

(57) ABSTRACT

A peg for the use in a construction industry is disclosed. The peg may include: a main longitudinal body configured to be inserted into a solid surface, and an indicator. The indicator may be configured to adaptively present visual quantitative information related to at least one of: a tip of the peg and construction task instructions. The indicator may include a scale notches for marking height such that the scale notches may be marked on at least a portion of the main longitudinal body. The peg may further include a marker for adaptively marking the solid surface related information.

### TECHNICAL FIELD OF THE INVENTION

The present invention generally relates to pegs for the construction industry. More particularly, the present invention relates to smart pegs for the construction industry.

### BACKGROUND OF THE INVENTION

The construction industry requires coordinates to be marked with physical visible markers, for example, pegs, stakes, nails, paint and the like. Laying out pegs is usually conducted by a team of two men: a global navigation satellite system (GNSS) or total station operator and an assistant who carries the pegs and hammers them in the desired coordinates. Sometimes the pegs are not high enough and replacement and re-staking may be required.

The currently used pegs indicate the height of the upper tip of the peg with respect to the building's zero level, the height of the upper tip of the peg with respect to the building's floor level and the like. Some pegs may further include additional information such as construction instructions marked (e.g., printed or hand drawn) on the surface of the peg. Commonly used pegs are marked by writing numbers or letters on the surface of the peg or with a colored ribbon. In some cases, the information is written on the ribbon. These markings are not adjustable or adaptable. Therefore, if an update of the information is required, the old information must be erased, or the ribbon may be replaced.

Furthermore, these pegs lack any indication regarding the distance of ground from the tip of the peg. Such height measurements are used today only in measuring the height of liquids, such as the sea level, lake level, a level of a liquid in a tank and the like.

Therefore, there is a need for smart pegs that may provide adjustable or adaptable information regarding the construction site, for example, the height of the ground at the peg's location.

### SUMMARY OF THE INVENTION

Some aspects of the invention may be related to peg, for example, a peg for the use in a consecration industry. The peg may include: a main longitudinal body configured to be inserted into a solid surface, and an indicator. In some embodiments, the indicator may be configured to adaptively present visual quantitative information related to at least one of: a tip of the peg and construction task instructions. In some embodiments, the indicator may include a scale notches for marking height such that the scale notches may be marked on at least a portion of the main longitudinal body. In some embodiments, the peg may further include a marker for adaptively marking the solid surface related information.

In some embodiments, the peg may include an extension configured to extend the length of the main longitudinal body. In some embodiments, the peg may include a connector for connecting the extension to the main longitudinal body. In some embodiments, the extension may be telescopically jointed with the main longitudinal body. In some embodiments, the extension may be configured to be bidirectionally screwed into and out from the main longitudinal body. In some embodiments, the extension further comprises an indicator extension. In some embodiments, the indicator and the indicator extension may include scale notches and the peg may be assembled such that the scale notches of the indicator extension extend the scale notches of the indicator.

In some embodiments, the peg may include a machine-readable element. In some embodiments, the peg may include at least one sensor. In some embodiments, the at least one sensor may be a height sensor for measuring the distance of the sensor from the solid surface. In some embodiments, the peg may include the at least one sensor may be at least one of: a humidity sensor, a thermometer, a positioning sensor and a camera. In some embodiments, the peg may include a controller including a communication unit configured so to send measurements from the sensor to a computing device. In some embodiments, the peg may include a leveler.

Some additional aspects of the invention may be related to a device for land marking. The device may include at least one pegs' application unit; and at least one pegs' container, for feeding pegs, according to any one of the embodiments of the invention, to the at least one pegs' application unit. In some embodiments, the pegs, according to any one of the embodiments of the invention are loaded into the at least one pegs' container.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an illustration of a peg according to some embodiments of the invention;

FIGS. 1B and 1C are illustrations of pegs according to some embodiments of the invention;

FIGS. 2A and 2B are illustrations of pegs with extensions according to some embodiments of the invention;

FIGS. 3A and 3B are illustrations of pegs with extensions according to some embodiments of the invention;

FIGS. 4A-4C are illustrations of pegs with extensions according to some embodiments of the invention;

FIGS. 5A-5C are illustrations of pegs with extensions according to some embodiments of the invention;

FIGS. 6A-6C are illustrations of pegs with extensions according to some embodiments of the invention; and

FIG. 7 is an illustration of a peg according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A peg according to some embodiments of the invention may be configured to be inserted in the surface (e.g., the surface of a construction site) and adaptively present visual quantitative information related to the tip of the peg and/or construction instructions. Such a peg may include an indicator that may be inspected by the user in order to extract the provided information. As used herein, adaptively present visual quantitative information may include any information related to at least one of: a tip of the peg and construction task instructions. For example, a peg according to some embodiments of the invention may provide the user information regarding: the height of tip of the peg from the building/construction site zero level, instruction at which height a construction task should reach/start (e.g., where to start the floor of a balcony), the height of the surface with respect to the tip of the peg, the absolute altitude, the coordinates at which the peg was inserted, the atmospheric conditions in the vicinity of the peg and the like. In some embodiments, the peg may include at least one extension configured to extend the length of the peg.

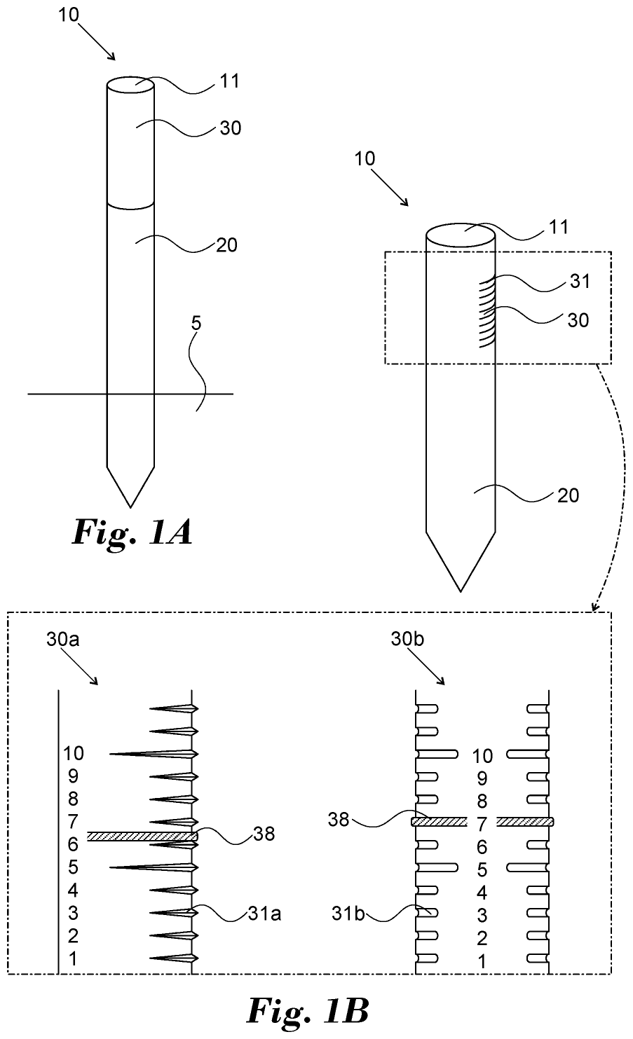

Reference is now made to FIG. 1A which is an illustration of a peg 10 according to some embodiments of the invention. Peg 10 may include a main longitudinal body 20 configured to be inserted into a solid surface 5 and an indicator 30. In some embodiments, indicator 30 may be configured to adaptively present visual quantitative information related to, for example, at least one of: an absolute height of an upper tip 11 of peg 10 (e.g., form the zero level of a building), the distance of upper tip 11 from solid surface 5 and/or the distance of a marker (e.g., marker 38 illustrated in FIG. 1B) included in indicator 30 from solid surface 5. In some embodiments, main longitudinal body 20 may be made from any material or a combination of materials that may allow main longitudinal body 20 to be inserted into surface 5. Surface 5 may be surface in a constructions site, for example, soil, rocky ground, concrete and the like. For example, main longitudinal body 20 may include at least one of: a metallic (e.g., steel, cast iron, etc.) portion, a polymeric portion, a wooden portion and the like.

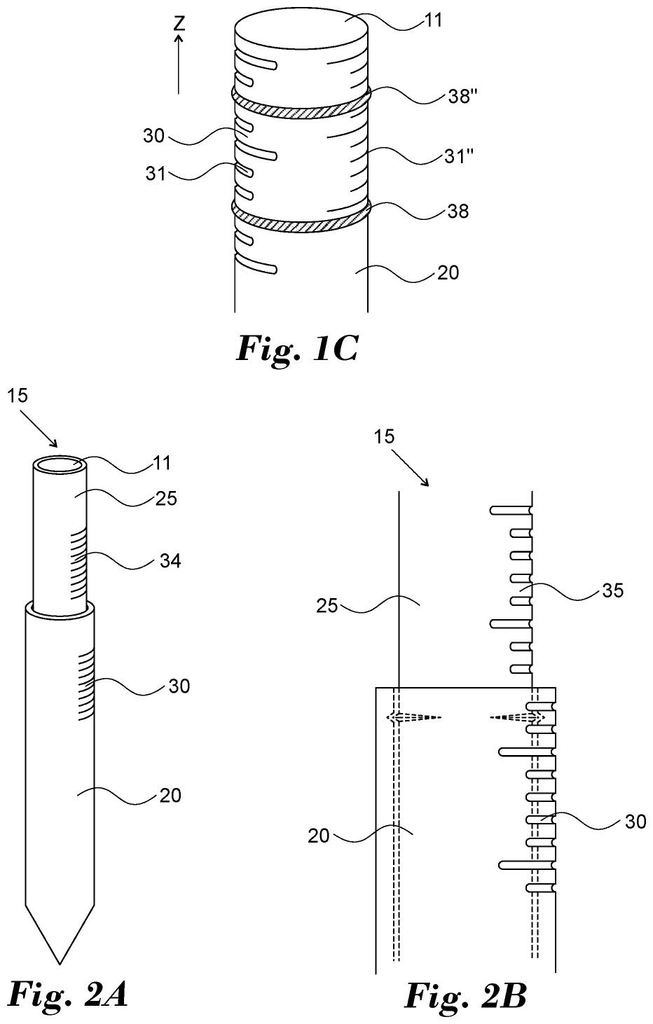

In some embodiments, indicator 30 may be attached to or marked on main longitudinal body 20. Examples of various indicators 30 and 130 are illustrated and given in FIGS. 2-7.

Reference is now made to FIG. 1B which is an illustration of a peg 10 according to some embodiments of the invention. In some embodiments, indicator 30 of peg 10 may include scale notches 31 for marking, for example, the distance of indicator 30 from tip 11 of peg 10 and/or the distance of indicator 30 from the solid surface (e.g., solid surface 5). In some embodiments, scale notches 31 may be marked on at least a portion of main longitudinal body 20, either as protrusions 31a included in indicator 30a or as grooves 31b included in indicator 30b. In some embodiments, indicator 30, 30a and/or 30b may further include a marker 38 (e.g., a ring) illustrated also in FIG. 1C for adaptively marking the quantitative related information, such as the distance information. For example, a user stacking peg 10 may measure a distance between tip 11 and surface 5 and may mark the distance by placing marker 38 at a desired location on indicator 30, 30a or 30b. It should be appreciated that more than one marker may be used on a single peg 10 to mark more than one quantitative information, such as a distance of marker 38 from tip 11 and distance of marker 38′ illustrated in FIG. 1C from ground level. According to some embodiments, two or more sets of scale notches 31 and 31′ may be used, to allow marking two or more different quantitative measures using a single marker 38 as illustrated in FIG. 1C. According to some embodiments, one or more sets of scale notches may be adjustable so that their relative location with respect to at least one other set of indicator notches may be changed along an axis of peg 10 (e.g., longitudinal axis Z of peg 10 in FIG. 1C, substantially orthogonal to surface 5 when peg 10 is in use) as illustrated and discussed with respect to FIG. 2A.

Reference is now made to FIGS. 2A and 2B which are illustrations of pegs 15 having extensions. Peg 15 may include main longitudinal body 20, indicator 30, and an extension 25 configured to extend the length of main longitudinal body 20. In some embodiments, extension 25 may telescopically be jointed with main longitudinal body 20, as illustrated in FIGS. 2A and 2B. In some embodiments, extension 25 may be pulled out from main body 20 and may be locked using a twist locking mechanism (as illustrated) or by any other suitable mechanism. In some embodiments, peg 15 may further include an indicator extension 34 or 35. In some embodiments, indicator 30 and indicator extension 35 may include the same set of scale notches (as illustrated in FIG. 2B) and peg 15 may be assembled such that the scale notches of indicator extension 35 extend the scale notches of indicator 30.

In some embodiments, indicator extension 34 may include a set of scale notches different form the set of scale notches included in indicator 30, such that indicator 30 may provide a first type of quantitative related information (e.g., the distance of tip 11 from surface 5) and indicator 35 may provide a second quantitative related information (e.g., the absolute height of tip 11) and peg may allow adjusting the relative distance between the upper notch of indicator 30 and the upper notch of indicator 34 by allowing a relative movement between longitudinal body 20 and extension 25.

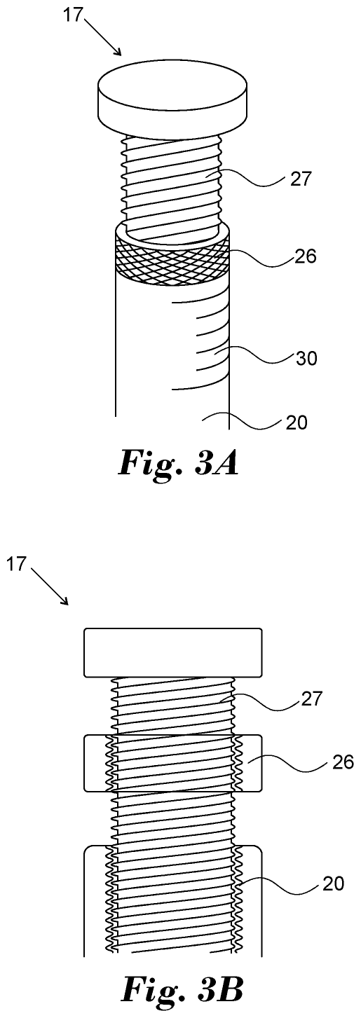

Reference is now made to FIGS. 3A and 3B which are illustrations of extended pegs 17 according to some embodiments of the invention. Peg 17 may include main longitudinal body 20, indicator 30, and an extension 27 configured to extend the length of main longitudinal body 20. In some embodiments, extension 27 may be configured to be bidirectionally screwed into and out from main longitudinal body 20. In some embodiments, when extension 27 is screwed out from main longitudinal body 20, peg 17 may be extended. In some embodiments, when extension 27 is screwed into main longitudinal body 20, peg 17 may be inserted into the surface (e.g., surface 5). In some embodiments, peg 17 may further include a locking ring 26 for locking extension 27 at a certain position.

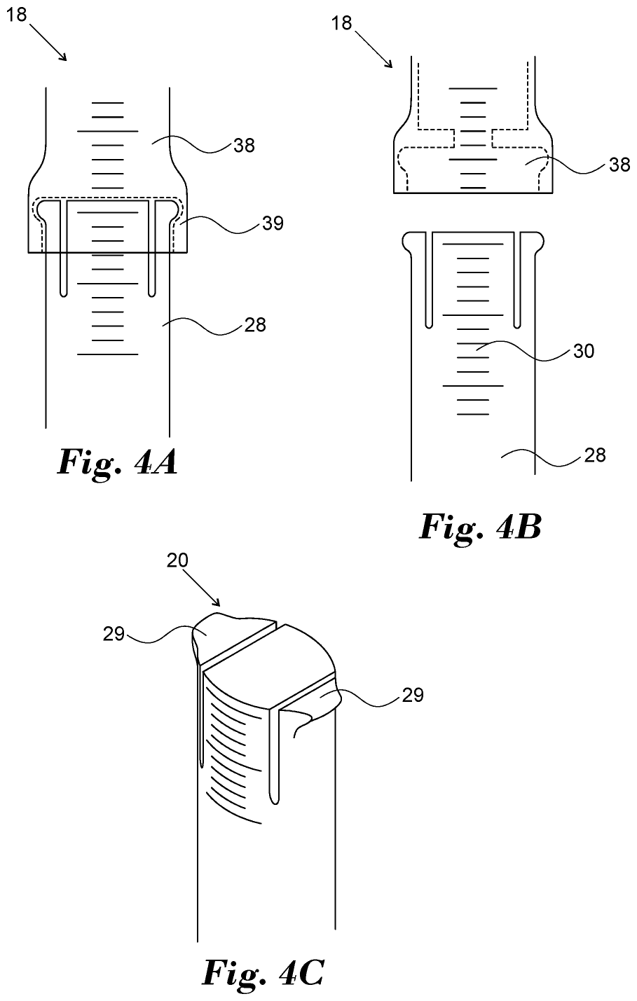

Reference is now made to FIGS. 4A-4B which are illustrations of extended pegs 18 according to some embodiments of the invention. Peg 18 may include main longitudinal body 28, indicator 30, and an extension 40 configured to extend the length of main longitudinal body 28. In some embodiments, hollow end 39 of extension 40 may be configured to be assembled on top of main body 28, and to press flexible plates 29 of main body 28 inwards. In some embodiments, hollow end 39 may include a bottom barrier for preventing extension 40 from sliding down. In some embodiments, flexible plates 29 may include embossed lock clips. In some embodiments, peg 18 may include more than on extension 38 and the invention, as a whole, is not limited to the number of extensions that may extend a peg. In such case extension 40 of peg 18 may include portions 29 at one end and hollow end 39 at the other end.

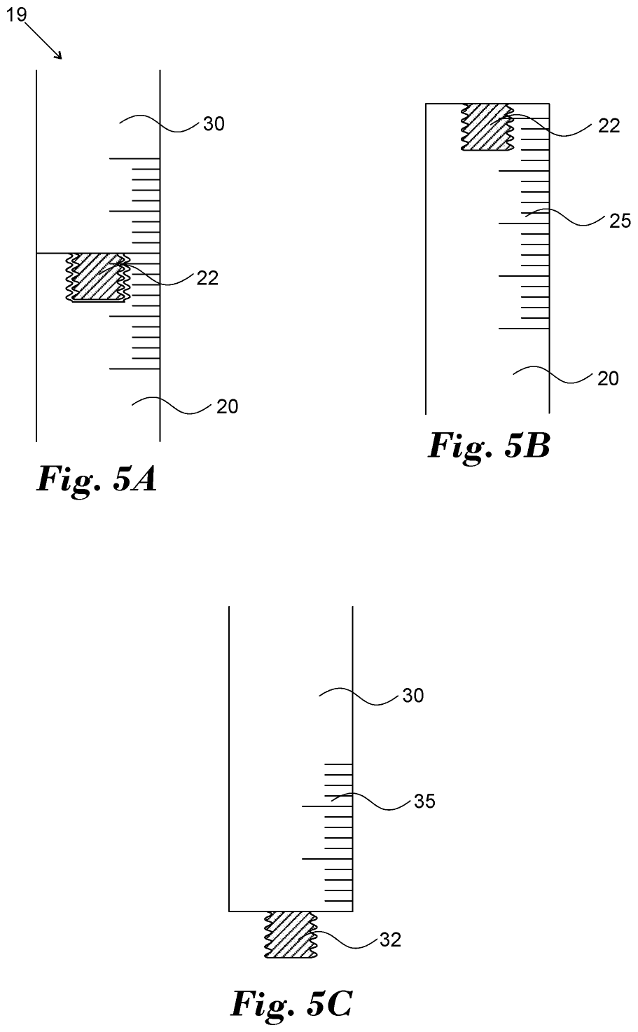

Reference is now made to FIG. 5A which is an illustration of an extended peg 19 according to some embodiments of the invention. Peg 19 may include main longitudinal body 20, indicator 30, and an extension 33 configured to extend the length of main longitudinal body 20 by being connected to main body using a connector or a connecting element 32. In some embodiments, main body 20, illustrated in FIG. 5B, may include a first connecting element 22, for example the illustrated thread, which may be configured to be connected to a second connecting element 32 of extension 33 (illustrated in FIG. 5C), for example, the illustrated screw. In some embodiments, peg 19 may include more than one extension, each having a thread in one end and a screw at the other end, to be screwed one on top of the other.

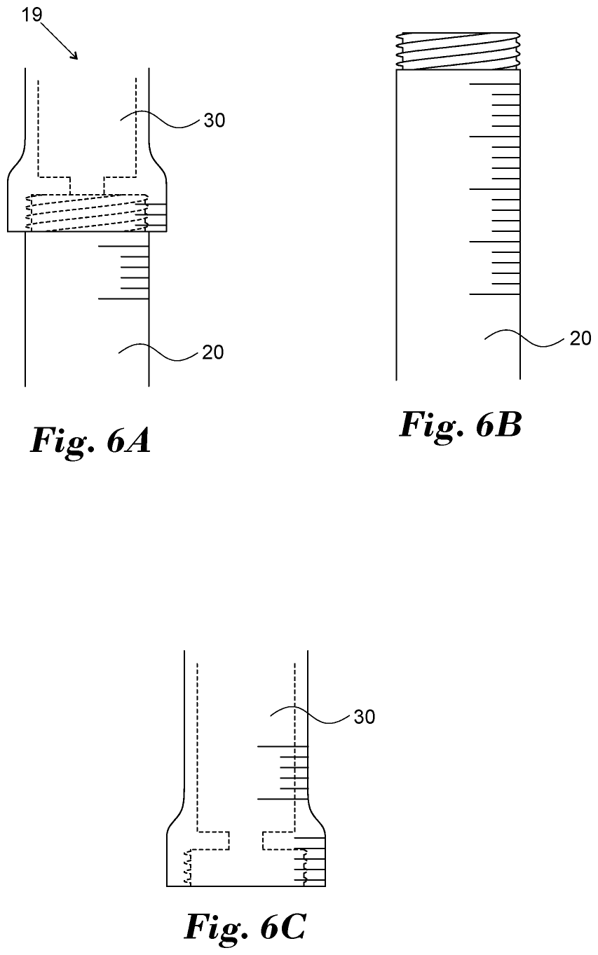

Similar arrangement is illustrated in FIGS. 6A-6C, in which peg 19 may also include main longitudinal body 20, indicator 30, and at least one extension 33. In the arrangement illustrated in FIGS. 6A-6C the thread is included in one end of extension 33 and the screw is included at the top end of main body 20.

In some embodiments, each one of pegs 15, 17, 18 and 19 illustrated in FIGS. 1-6 may include two or more sets of scale notches and may further be adjustable so that their relative location with respect to at least one other set of scale notches may be changed along a longitudinal axis Z of pegs 15, 17, 18 and 19 as illustrated and discussed with respect to FIG. 2A.

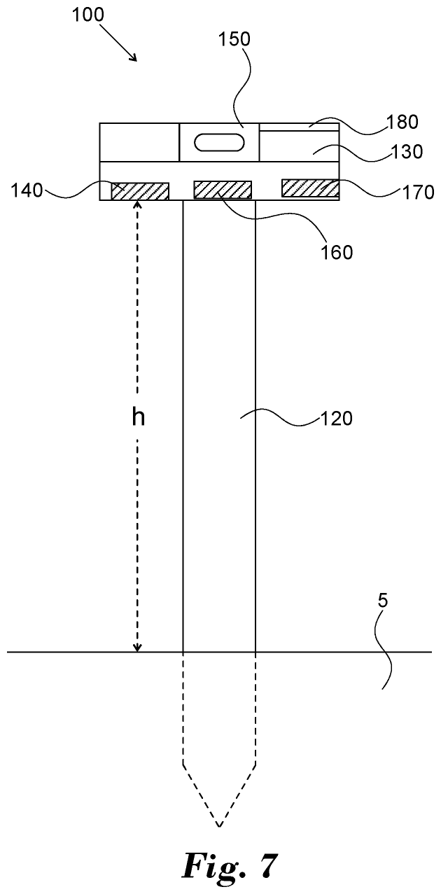

Reference is now made to FIG. 7 which is an illustration of a peg 100 according to some embodiments of the invention. Peg 100 may include a main longitudinal body 120, an indicator 130 and at least one sensor 140. In some embodiments, main longitudinal body 120 may be substantially the same as main longitudinal body 20, 27 and 28 discussed herein above. In some embodiments, main longitudinal body 20 may be extended using any known extension, for example, the extensions discussed hereinabove. In some embodiments, indicator 130 may include scale notches or may include any other indicator. For example, indicator 130 may include a text printed or marked on the surface of body 120. Indicator 130 may be configured to adaptively present visual quantitative information related to solid surface 5.

In some embodiment, indicator 130 may include electronic components, such as, a controller 160, a power supply 170 and a display 180. In some embodiments, at least some of the electronic components of indicator 130 may be included in a printed circuit board (PCB). Controller 160 may include: a processor, a memory and a communication unit (e.g., a wireless communication unit) and may be configured to receive, process, store and send information from and to an external device, for example, a mobile computing device operated by an operator. Power supply 170 may be, for example, a battery, and display 180 may be any display configured to present the visual quantitative information to a user. For example, display 180 may present the coordinates of peg 100 received from the operator. In another example, display 180 may present measurements received from sensor 140, for example, the distance h from sensor 140 to surface 5. In some embodiments, an operator staking the peg may upload (e.g., via the communication unit) the coordinates into controller 160, for example, using an application running on his mobile device. In some embodiments, the coordinates may be received automatically from a positioning sensor (e.g., sensor 140), such as, GPS included in peg 100.

In some embodiments, sensor 140 may be a height sensor for measuring the distance h of the sensor from solid surface 5, as illustrated. For example, sensor 140 may include a laser beam configured to be directed downward towards surface 5 or may be directed to the surface at a known angle (e.g., an angle formed between the laser beam and a line parallel to the earth gravitation force). In some embodiments, sensor 140 may be configured to measure the distance of various locations around peg 100, by changing the angle and direction of the laser beam. In some embodiments, sensor 140 may include at least one of: a humidity sensor, a thermometer, a barometer, a positioning sensor (e.g., a global position sensor (GPS), a camera and the like.

In some embodiments, peg 100 (and also pegs 10, 15, 17, 18 and 19) may include a leveler 150. Leveler 150 may provide an operator an assistance in staking the peg perpendicular to the surface or to the horizon.

In some embodiments, pegs 10, 15, 17 19 and/or 100 may further include a machine-readable element (e.g., a tag, an RFID or a QR code) configured to be read by a reader. The machine-readable element may include identification information related to the peg. The identification information may be associated with information such as the quantitative information related to at least one of: the tip of the peg and construction task instructions and may be presented to the user on an external screen, for example, a screen of a mobile device.

Some additional aspects of the invention may be related to a device for land marking. The device may include at least one pegs' application unit; and at least one pegs' container, for feeding one or more pegs 10, 15, 17 19 and/or 100 to the at least one pegs' application unit. In some embodiments, peg's application unit may be any unit/device that is configured to apply pegs at a location, for example, a location in a construction site. In some embodiments, the at least one pegs' container may be any magazine, cartridge, and the like that is configured to be loaded with pegs and feed pegs into peg's application unit. Some non-limiting examples for peg's application units are given herein below.

For example, the peg's application unit may include one or more pressurized gas tanks configured to dispatch one or more pegs 10, 15, 17 19 or 100 using the driving force of the gas. In another example, the peg's application unit may include a driller for drilling a hole in the ground and an insertion mechanism (e.g., a piston or a screwing device) for inserting peg 10, 15, 17 19 or 100 into the hole. In yet another example, the peg's application unit may include two pistons configured to provide an angular moment to pegs 10, 15, 17 19 or 100, including a self-drilling screw at the bottom of each peg.

In another nonlimiting example, a peg to be inserted using the land marking device according to some embodiments of the invention may include a wide top for pounding/drilling/hammering the peg. The wide top may include at least one indicator, wherein the indicator (e.g., indicator 30 or 130) may be configured to adaptively present quantitative information related to at least one of: a tip of the peg and construction task instructions. In some embodiments, the peg may further include a loading element (e.g., in the form of one or more protrusions) for extracting and/or loading the peg from the at least one pegs' container into the peg's application unit. In some embodiments, the bottom part of the peg may include any structure that may allow inserting the peg into the land, either previously drilled or by self-drilling/self-insertion. For example, the bottom part of the peg may include a cone shape, a screw and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A peg, comprising:
a main longitudinal body configured to be inserted into a solid surface; and
an indicator, wherein the indicator is configured to adaptively present visual quantitative information related to at least one of: a tip of the peg and construction task instructions.

2. The peg of claim 1, wherein the indicator includes a scale notches for marking height and wherein the scale notches are marked on at least a portion of the main longitudinal body.

3. The peg of claim 2, further comprising a marker for adaptively marking information related to the solid surface.

4. The peg of claim 1, further comprising a machine-readable element.

5. The peg of claim 1, further comprising:
an extension configured to extend the length of the main longitudinal body.

6. The peg of claim 5, further comprising a connector for connecting the extension to the main longitudinal body.

7. The peg of claim 5, wherein the extension is telescopically jointed with the main longitudinal body.

8. The peg of claim 5, wherein the extension is configured to be bidirectionally screwed into and out from the main longitudinal body.

9. The peg of claim 5, wherein the extension further comprises an indicator extension.

10. The peg of claim 9, wherein the indicator and the indicator extension comprise scale notches, and the peg is assembled such that the scale notches of the indicator extension extend the scale notches of the indicator.

11. The peg of claim 1, further comprising at least one sensor.

12. The peg of claim 11, wherein the at least one sensor is a height sensor for measuring the distance of the sensor from the solid surface.

13. The peg of claim 11, wherein the at least one sensor is at least one of: a humidity sensor, a thermometer, a positioning sensor and a camera.

14. The peg of claim 11, further comprising a controller comprising a communication unit configured so to send measurements from the sensor to a computing device.

15. The peg of claim 1, further comprising a leveler.

16. A device for land marking, the device comprising
at least one pegs' application unit; and
at least one pegs' container, for feeding one or more pegs to the at least one pegs' application unit,
wherein the at least one pegs' container is loaded with one or more pegs according to claim 1.
